(19) United States
(12) Patent Application Publication
(10) Pub. No.: US 2024/0070528 A1
(43) Pub. Date: Feb. 29, 2024

(54) EXTREMELY RANDOMIZED BOOTSTRAP AGGREGATION SYSTEMS AND METHODS

(71) Applicant: Capital One Services, LLC, McLean, VA (US)

(72) Inventor: Michael Langford, Plano, TX (US)

(21) Appl. No.: 17/899,907

(22) Filed: Aug. 31, 2022

(51) Int. Cl. G06N 20/00

(52) U.S. Cl. CPC G06N 20/00

(57) ABSTRACT

Systems and methods are provided for evaluating and selecting an ensemble of machine language models using extremely randomized bootstrap aggregation (e.g., bagging) with replacement. The method may include the use of a plurality of base models to produce a combined (or aggregated) output. Original data may be randomly sampled with replacement to create N subsets of bootstrapped data for which each of the N-selected base models may produce a prediction based on their subset of data. The individual predictions may be combined and evaluated, and an ensemble having the highest performance may be selected and trained for production. Certain implementations of the disclosed technology can eliminate the need for apriori knowledge about which model (or models) will provide accurate predictions.

### FIELD

This disclosure generally relates to machine learning models, and in particular, to systems and methods for training randomized ensembles of models on training datasets and selecting effective ensembles based on evaluating the trained ensembles using a validation dataset and one or more evaluation metrics.

### BACKGROUND

Traditional decision tree ensemble machine learning methods combine predictions of two or more decision trees to produce robust predictions on unseen data. Such ensemble learning can involve the use of different training data so that a consolidated decision may be made. In this respect, multiple independent and diverse decisions may be combined to cancel-out random errors while correct decisions are reinforced.

There are many decision tree models, including a “random forest” which trains many different copies of a decision tree on randomly sampled subsets of a dataset. In this respect, each decision tree can get a different perspective of the input dataset, and then all of the decision trees in this “forest” can “vote” in an ensemble on the importance of the data.

Ensemble machine learning may be used for many industrial applications to help reduce the variance of machine learning models used in production. A common method of producing and training machine learning models using ensemble methods is called bootstrap aggregation, or “bagging,” which trains multiple copies of one type of estimator on randomly sampled subsets (with replacement) of an original training dataset.

Random forest models can be used for bagging, in which simple decision trees are trained on subsets of the training set, and their predictions are combined to produce an ensemble prediction on unseen data. Existing ensemble methods that utilize randomized trees train an ensemble of decision trees with random feature splits into random subsets of the training data without replacement. Ensemble methods that use bagging beyond just using a simple decision tree base model can be incredibly useful at reducing variance in ensembles but even experienced data scientists may have great difficulty in selecting good base models and hyperparameter combinations to properly optimize a bagging ensemble method.

Accordingly, there is a need for improved systems and methods for ensemble machine learning utilizing bagging techniques. Embodiments of the present disclosure are directed to this and other considerations.

### BRIEF SUMMARY

The systems and methods disclosed herein may be utilized for training randomized ensembles of models on training datasets and selecting effective ensembles based on evaluating the trained ensembles.

Consistent with the disclosed embodiments, a method is provided for evaluating and selecting an ensemble of machine language models that may employ extremely randomized bootstrap aggregation (bagging) with replacement. The method may include receiving a configuration file that specifies a sub-group of base models selected from a group of available models, base estimators, and available hyperparameter values associated with each of the base estimators. The method may include receiving an input training dataset, a validation dataset, an integer specifying the number of trials to build and train an extremely randomized ensemble, and a range specifying a minimum and a maximum number of the base estimators to be contained in a single randomized ensemble, and one or more evaluation metrics to evaluate a trained ensemble on the validation dataset. The method further may include selecting, with replacement and from the received configuration file, a random number of base estimators within the range specifying the minimum and a maximum number of base estimators, training each model of an ensemble of models as specified by the sub-group of base models using a random sample of the input training dataset and using a random set of the available hyperparameter values, generating, by the trained models using the validation dataset, individual predictions for each record in the validation dataset, scoring, using the evaluation metric, effectiveness of each ensemble of models based on the generated individual predictions and known outputs of the validation dataset, selecting a most effective ensemble of models based on the scoring, and outputting the most effective ensemble including associated base estimators and hyperparameters.

Consistent with the disclosed embodiments, a system is provided that may include a processor and memory comprising instructions that when executed by the processor cause the processor to receive a configuration file specifying a sub-group of base models selected from a group of available models, base estimators, and available hyperparameter values associated with each of the base estimators. The instructions further cause the processor to receive an input training dataset, a validation dataset, an integer specifying the number of trials to build and train an extremely randomized ensemble, and a range specifying a minimum and a maximum number of the base estimators to be contained in a single randomized ensemble, and one or more evaluation metrics to evaluate a trained ensemble on the validation dataset. The instructions further cause the processor to select, with replacement and from the received configuration file, a random number of base estimators within the range specifying the minimum and a maximum number of base estimators. The instructions further cause the processor to train each model of an ensemble of models as specified by the sub-group of base models using a random sample of the input training dataset and using a random set of the available hyperparameter values. The instructions further cause the processor to generate, by the trained models using the validation dataset, individual predictions for each record in the validation dataset, score, using the evaluation metric, effectiveness of each ensemble of models based on the generated individual predictions, and known outputs of the validation dataset, select a most effective ensemble of models based on the scoring, and output the most effective ensemble including associated base estimators and hyperparameters.

Consistent with the disclosed embodiments, A non-transitory computer-readable medium comprising a set of instructions that, in response to being executed by a processor circuit, cause the processor circuit to perform a method of receiving a configuration file that specifies a sub-group of base models selected from a group of available models, base estimators, and available hyperparameter values associated with each of the base estimators. The method may include receiving an input training dataset, a validation dataset, an integer specifying the number of trials to build and train an extremely randomized ensemble, and a range specifying a minimum and a maximum number of the base estimators to be contained in a single randomized ensemble, and one or more evaluation metrics to evaluate a trained ensemble on the validation dataset. The method further may include selecting, with replacement and from the received configuration file, a random number of base estimators within the range specifying the minimum and a maximum number of base estimators, training each model of an ensemble of models as specified by the sub-group of base models using a random sample of the input training dataset and using a random set of the available hyperparameter values, generating, by the trained models using the validation dataset, individual predictions for each record in the validation dataset, scoring, using the evaluation metric, effectiveness of each ensemble of models based on the generated individual predictions and known outputs of the validation dataset, selecting a most effective ensemble of models based on the scoring, and outputting the most effective ensemble including associated base estimators and hyperparameters.

Further features of the disclosed design and the advantages offered thereby are explained in greater detail hereinafter regarding specific embodiments illustrated in the accompanying drawings, wherein like elements are indicated to be like reference designators.

### BRIEF DESCRIPTION OF THE DRAWINGS

Reference will now be made to the accompanying drawings, which are not necessarily drawn to scale, and which illustrate various implementations and aspects of the disclosed technology and, together with the description, serve to explain the principles of the disclosed technology.

FIG. 1 is a general illustration of an extremely randomized bootstrap aggregation (bagging) process in which a plurality of base models may be used to produce a combined output, according to an exemplary embodiment of the disclosed technology.

FIG. 2 is a detailed illustration of an extremely randomized bootstrap aggregation (bagging) process according to an exemplary implementation of the disclosed technology in which base model selection may be refined.

FIG. 3 depicts a system with interacting processes, and associated modules for extremely randomized bagging implementations in accordance with certain embodiments of the disclosed technology.

FIG. 4. illustrates simplified hardware and software components that may be utilized in certain exemplary implementations of the disclosed technology.

FIG. 5 is a block diagram of a computing device that may be utilized in the system, in accordance with certain example implementations of the disclosed technology.

FIG. 6 is a flow diagram of a method, according to an exemplary implementation of the disclosed technology.

### DETAILED DESCRIPTION

The disclosed technology provides an extension beyond previous ensemble systems and methods, such as randomized tree ensemble methods, in which decision tree models in an ensemble are trained using random feature splits on random subsets of the training dataset without replacement. In accordance with certain exemplary implementations of the disclosed technology, various models/estimators (not just decision trees) can be combined in an ensemble and evaluated. In this respect, the disclosed technology can eliminate the need for the user to know which model(s)/estimator(s) to use, which is one of the biggest challenges in machine learning.

Consistent with this disclosure, certain implementations of the systems and/or methods described herein may be utilized to create bootstrap aggregation (bagging) ensemble processes. Bagging, as discussed herein, may be utilized to construct N classifiers using bootstrap sampling of the training data. The resulting predictions from the N classifiers may be combined to produce an improved meta-prediction.

Throughout this disclosure, the terms “estimator” and “model” may be used interchangeably unless otherwise specified. Throughout this disclosure, the term “classifier” may be considered a subset of an estimator or model when used in classification machine learning tasks, such as classifying whether a dataset indicates fraud or not fraud. Additionally, the term “regressor” may be used to describe models/estimators when predicting a continuous value rather than a binary class.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive.

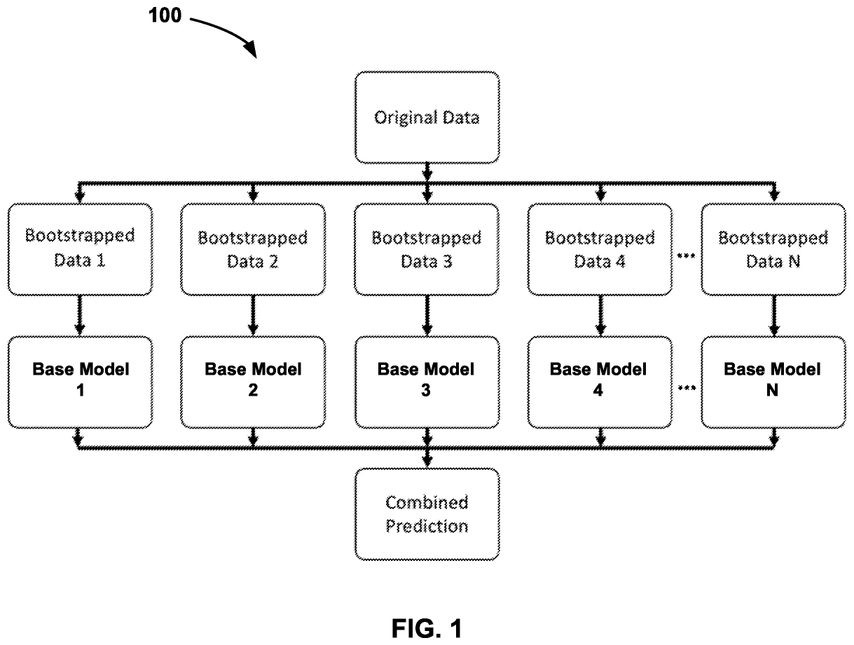

FIG. 1 illustrates an extremely randomized bootstrap aggregation (bagging) process in which a plurality of base models/estimators may be used to produce a combined output, according to an exemplary embodiment of the disclosed technology. The process of sampling subsets with replacements is known as bootstrapping. The term “extremely” in this regard is intended to indicate that the bagging process may construct multiple decision trees during training over every observation in the dataset, but with different subsets of features. In certain exemplary implementations, base models may be randomly selected from available models for use in a given ensemble. In certain exemplary implementations, the base models may utilize randomized hyperparameter combinations for each model.

An advantage of the extremely randomized bagging process is that it can reduce bias and/or variance, for example, when sampling from the entire dataset during the construction of decision trees. Different subsets of the data, for example, may introduce different biases and/or variance in the results obtained and the extremely randomized bagging process can help reduce or prevent such bias and/or variance by sampling the entire dataset and by combining (aggregating) the predictions of each model. In certain exemplary implementations, the extremely randomized bagging process may utilize randomized splitting of nodes within the decision trees, which may reduce the influence of certain features or patterns in the dataset.

In accordance with certain exemplary implementations of the disclosed technology, the original data may be randomly sampled with replacement to create N subsets of bootstrapped data and for which each of the N-selected base models may produce a prediction based on their subset of data. The individual predictions may be combined and evaluated. In accordance with certain exemplary implementations of the disclosed technology, the above-referenced N classifiers may be constructed using base models that are selected based on instructions in a configuration file.

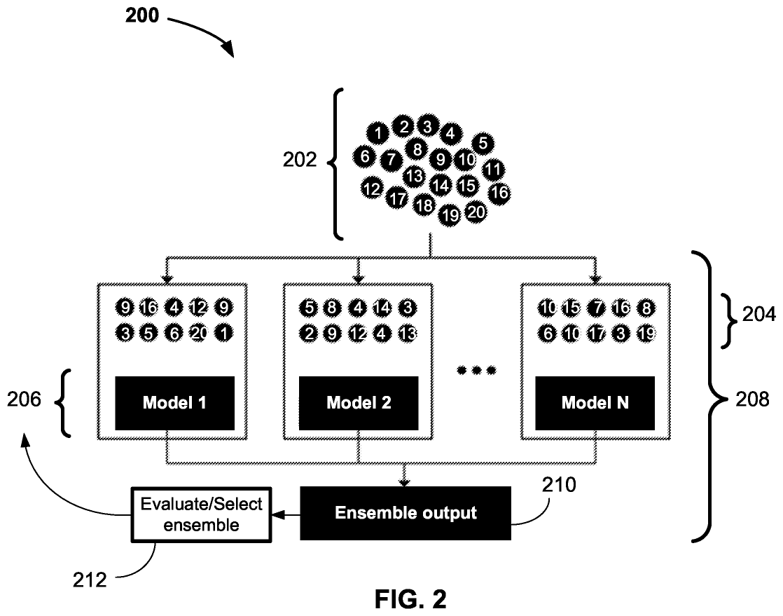

FIG. 2 illustrates certain details of an extremely randomized bagging process according to an exemplary implementation of the disclosed technology in which base model selection may be refined. In this example, an original dataset 202 may be sampled with replacement to produce N subsets of bootstrapped data 204 for feeding corresponding N base models 206 in the bagging process 208. Since each sample that is randomly selected from the original dataset 202 is replaced before the next sampling, it is possible to have duplicate samples within the individual subsets (as illustrated by duplicate sample #9 in the subset sent to Model 1). It is also likely that there will be an overlap of bootstrapped data 204 among each of the N subsets of bootstrapped data 204.

In accordance with certain exemplary implementations of the disclosed technology, the output (or prediction) from a random selection of the base models 206 may be combined in an ensemble output 210, which may be evaluated based on a selected validation metric. In certain exemplary implementations, the ensemble having the highest score may be selected, re-trained, and saved. In certain exemplary implementations, base estimators and/or hyperparameters may be output, for example, to preserve and enable the use of the best performing ensemble method for later experimentation or production. In this respect, the ensemble having the highest score may be selected for production without requiring that a user know and/or select which estimator to use.

According to an exemplary implementation of the disclosed technology, base estimators (or models) can include but are not limited to decision trees, logistic regression, K-Nearest Neighbor (KNN), etc. KNN, for example, is a data classification method for estimating the likelihood that a data point will become a member of a group based on the nearest data points to that group. A hyperparameter may be considered a machine learning parameter whose value is chosen before a learning algorithm is trained. Hyperparameters can include but are not limited to model architecture, learning rate, number of epochs, number of branches in a decision tree, number of clusters in a clustering algorithm, etc.

In accordance with certain implementations, example hyperparameters that may be used with decision tree estimators can include the number of decision trees used in the ensemble. Other example hyperparameters that may be used with decision tree estimators can include maximum tree depth. Example hyperparameters that may be used with logistic regression estimators can include learning rate, solver, penalty, regularization strength, etc. An example hyperparameter that may be used with KNN is K, or the number of nearest neighbors to use for classifying which group a data point belongs to. The estimators and hyperparameters listed here are just a few examples and are not intended to limit the scope of the disclosed technology.

The extremely randomized bagging ensemble methods disclosed herein may provide the technical benefit of reducing training time, particularly in comparison to ensemble methods that utilize random forest models. Training, for example, can be done using a cluster of computing resources because training each base estimator can be done independently and in parallel, which can improve training and trial run time dramatically. Certain exemplary implementations of the disclosed technology may utilize randomized base models that have high variances, and their prediction outputs may be averaged together to create a robust ensemble method that reduces variance without having to spend valuable data scientist time and effort in model selection and training.

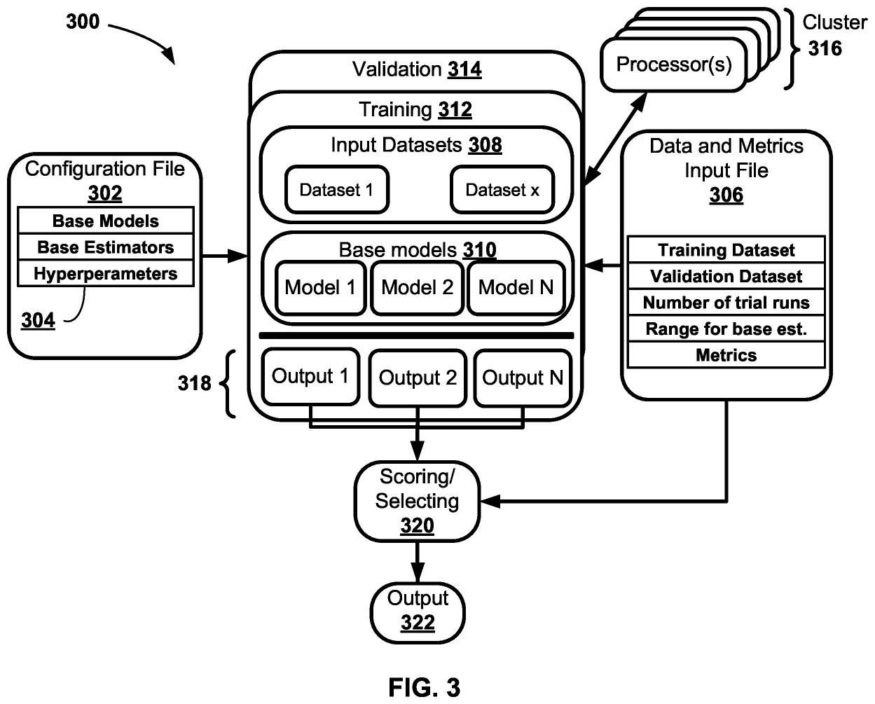

FIG. 3 depicts a system 300 with interacting processes, and associated modules for extremely randomized bagging implementations in accordance with certain embodiments of the disclosed technology.

In accordance with certain exemplary implementations of the disclosed technology, the system 300 may utilize as input, a configuration file 302 to specify all the base models 310 from which the system 300 may select to form a given ensemble (such as the ensemble using selected base models 206 depicted in FIG. 2). In certain exemplary implementations, the configuration file 302 may also provide parameters 304 including but not limited to base estimators and/or hyperparameters for use with the base models. Additionally, the system 300 may utilize as input, the data and metrics input file 306, which can include an input training dataset, a validation dataset, a specified number of trial runs to build and train an extremely randomized ensemble, a minimum and a maximum number of models to be contained in a single randomized ensemble, and/or one or more evaluation metric(s) to evaluate the ensemble on the validation dataset. In certain exemplary implementations, the data and metrics input file 306 can include any edits to the configuration file for building the base models 310. In certain exemplary implementations, the configuration file 302 may include some or all of the information in the data and metrics input file 306.

For each trial among the number of runs as specified in the data and metrics input file 306, the system 300 may select (with replacement) a random number of base estimators from the configuration file 302 within the range of minimum and the maximum total number of models specified in the data and metrics 306 input file. Then, each one of these base models 310 may be trained on a random sample of the training data in the input datasets 308, with replacement, and with a random set of hyperparameters chosen from the configuration file 302.

In accordance with certain exemplary implementations of the disclosed technology, the training can be performed using one or more processors. In certain exemplary implementations, a cluster 316 of computing resources may be utilized to individually train each of the base estimators and/or base models 310 in parallel. Using the cluster 316 of processors for this training can dramatically reduce the associated run time. Once all base estimators and/or models 310 are trained 312 on their respective training dataset subsets (input datasets 308), the validation process 314 may utilize the validation dataset specified in the data and metrics input file 306. The validation dataset, for example, may be sampled with replacement and used for the individual input datasets 308 and the base models 310 in the ensemble may generate outputs 318 (or predictions) on the validation dataset. The outputs 318 may then be averaged together for each observation.

In accordance with certain exemplary implementations of the disclosed technology, one or more validation metrics (as specified in the data and metrics input file 306) may be applied to evaluate and/or score 320 the ensemble's effectiveness on the validation set. The system 300 may output 322 the trained ensemble base models and may provide logged hyperparameters and the validation metric(s) used. Once the system 300 has trained a number of ensembles equal to the total number of trial runs specified, the ensemble with the highest validation metric may be selected, re-trained, and saved, with all base estimators and hyperparameters provided.

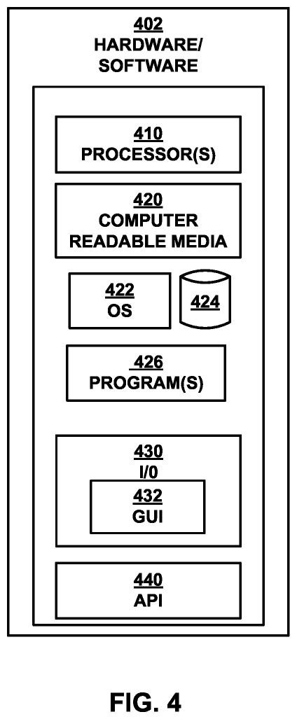

FIG. 4 is a simple block diagram of example hardware and software 402 components that may be utilized according to an aspect of the disclosed technology, which may include one or more of the following: one or more processors 410, a non-transitory computer-readable medium 420, an operating system 422, memory 424, one or more programs 426 including instructions that cause the one or more processors 410 to perform certain functions; an input/output (“I/O”) device 430, and an application program interface (API) 440, among other possibilities. The I/O device 430 may include a graphical user interface 432.

In certain embodiments, the API interface 440 may utilize real-time APIs. In certain aspects, the API may allow a software application, which is written against the API and installed on a client to exchange data with a server that implements the API in a request-response pattern. In certain embodiments, the request-response pattern defined by the API may be configured synchronously and require that the response be provided in real-time. In some embodiments, a response message from the server to the client through the API consistent with the disclosed embodiments may be in the format including, for example, Extensible Markup Language (XML), JavaScript Object Notation (JSON), and/or the like.

In some embodiments, the API design may also designate specific request methods for a client to access the server. For example, the client may send GET and POST requests with parameters URL-encoded (GET) in the query string or form-encoded (POST) in the body (e.g., a form submission). Alternatively, the client may send GET and POST requests with JSON serialized parameters in the body. Preferably, the requests with JSON serialized parameters use “application/j son” content type. In another aspect, an API design may also require the server to implement the API return messages in JSON format in response to the request calls from the client.

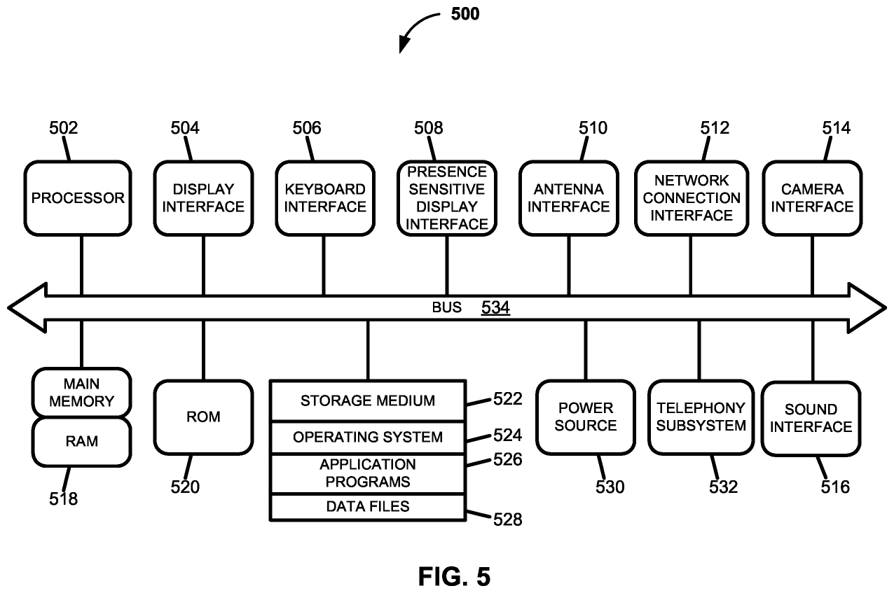

FIG. 5 depicts a block diagram of an illustrative computing device 500 that may be utilized to enable certain aspects of the disclosed technology. Various implementations and methods herein may be embodied in non-transitory computer-readable media for execution by a processor. It will be understood that the computing device 500 is provided for example purposes only and does not limit the scope of the various implementations of the communication systems and methods.

The computing device 500 of FIG. 5 may include one or more processors where computer instructions are processed. The computing device 500 may comprise the processor 502, or it may be combined with one or more additional components shown in FIG. 5. In some instances, a computing device may be a processor, controller, or a central processing unit (CPU). In yet other instances, a computing device may be a set of hardware components, such as depicted in FIG. 4.

The computing device 500 may include a display interface 504 that acts as a communication interface and provides functions for rendering video, graphics, images, and texts on the display. In certain example implementations of the disclosed technology, the display interface 504 may be directly connected to a local display. In another example implementation, the display interface 504 may be configured for providing data, images, and other information for an external/remote display. In certain example implementations, the display interface 504 may wirelessly communicate, for example, via a Wi-Fi channel or other available network connection interface 512 to the external/remote display.

In an example implementation, the network connection interface 512 may be configured as a communication interface and may provide functions for rendering video, graphics, images, text, other information, or any combination thereof on the display. For one example, a communication interface may include a serial port, a parallel port, a general-purpose input and output (GPIO) port, a game port, a universal serial bus (USB), a micro-USB port, a high-definition multimedia (HDMI) port, a video port, an audio port, a Bluetooth port, a near-field communication (NFC) port, another like communication interface, or any combination thereof. In one example, the display interface 504 may be operatively coupled to a local display. In another example, the display interface 504 may wirelessly communicate, for example, via the network connection interface 512 such as a Wi-Fi transceiver to the external/remote display.

The computing device 500 may include a keyboard interface 506 that provides a communication interface to a keyboard. According to certain example implementations of the disclosed technology, the presence-sensitive display interface 508 may provide a communication interface to various devices such as a pointing device, a touch screen, etc.

The computing device 500 may be configured to use an input device via one or more input/output interfaces (for example, the keyboard interface 506, the display interface 504, the presence-sensitive display interface 508, network connection interface 512, camera interface 514, sound interface 516, etc.) to allow a user to capture information into the computing device 500. The input device may include a mouse, a trackball, a directional pad, a trackpad, a touch-verified trackpad, a presence-sensitive trackpad, a presence-sensitive display, a scroll wheel, a digital camera, a digital video camera, a web camera, a microphone, a sensor, a smartcard, and the like. Additionally, the input device may be integrated with the computing device 500 or may be a separate device. For example, the input device may be an accelerometer, a magnetometer, a digital camera, a microphone, and an optical sensor.

Example implementations of the computing device 500 may include an antenna interface 510 that provides a communication interface to an antenna; a network connection interface 512 that provides a communication interface to a network. According to certain example implementations, the antenna interface 510 may utilize to communicate with a Bluetooth transceiver.

In certain implementations, a camera interface 514 may be provided that acts as a communication interface and provides functions for capturing digital images from a camera. In certain implementations, a sound interface 516 is provided as a communication interface for converting sound into electrical signals using a microphone and for converting electrical signals into sound using a speaker. According to example implementations, random-access memory (RAM) 518 is provided, where computer instructions and data may be stored in a volatile memory device for processing by the CPU 502.

According to an example implementation, the computing device 500 may include a read-only memory (ROM) 520 where invariant low-level system code or data for basic system functions such as basic input and output (I/O), startup, or reception of keystrokes from a keyboard are stored in a non-volatile memory device. According to an example implementation, the computing device 500 may include a storage medium 522 or other suitable types of memory (e.g. RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 524, application programs 526 (including, for example, a web browser application, a widget or gadget engine, and or other applications, as necessary) and data files 528 are stored. According to an example implementation, the computing device 500 may include a power source 530 that provides an appropriate alternating current (AC) or direct current (DC) to power components. According to an example implementation, the computing device 500 may include a telephony subsystem 532 that allows the device 500 to transmit and receive sound over a telephone network. The constituent devices and the CPU 502 communicate with each other over a bus 534.

In accordance with an example implementation, the CPU 502 has an appropriate structure to be a computer processor. In one arrangement, the computer CPU 502 may include more than one processing unit. The RAM 518 interfaces with the computer bus 534 to provide quick RAM storage to the CPU 502 during the execution of software programs such as the operating system application programs, and device drivers. More specifically, the CPU 502 loads computer-executable process steps from the storage medium 522 or other media into a field of the RAM 518 to execute software programs. Data may be stored in RAM 518, where the data may be accessed by the computer CPU 502 during execution. In one example configuration, the device 500 may include at least 128 MB of RAM, and 256 MB of flash memory.

The storage medium 522 itself may include a number of physical drive units, such as a redundant array of independent disks (RAID), a floppy disk drive, a flash memory, a USB flash drive, an external hard disk drive, a thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer-readable storage media allow the device 500 to access computer-executable process steps, application programs, and the like, stored on removable and non-removable memory media, to off-load data from the device 500 or to upload data onto the device 500. A computer program product, such as one utilizing a communication system may be tangibly embodied in storage medium 522, which may comprise a machine-readable storage medium.

According to one example implementation, the term computing device, as used herein, may be a CPU, or conceptualized as a CPU (for example, the CPU 502 of FIG. 5). In this example implementation, the computing device (CPU) may be coupled, connected, and/or in communication with one or more peripheral devices.

Following certain exemplary implementations of the disclosed technology, one or more features may be pre-computed and stored for later retrieval and used to provide improvements in processing speeds.

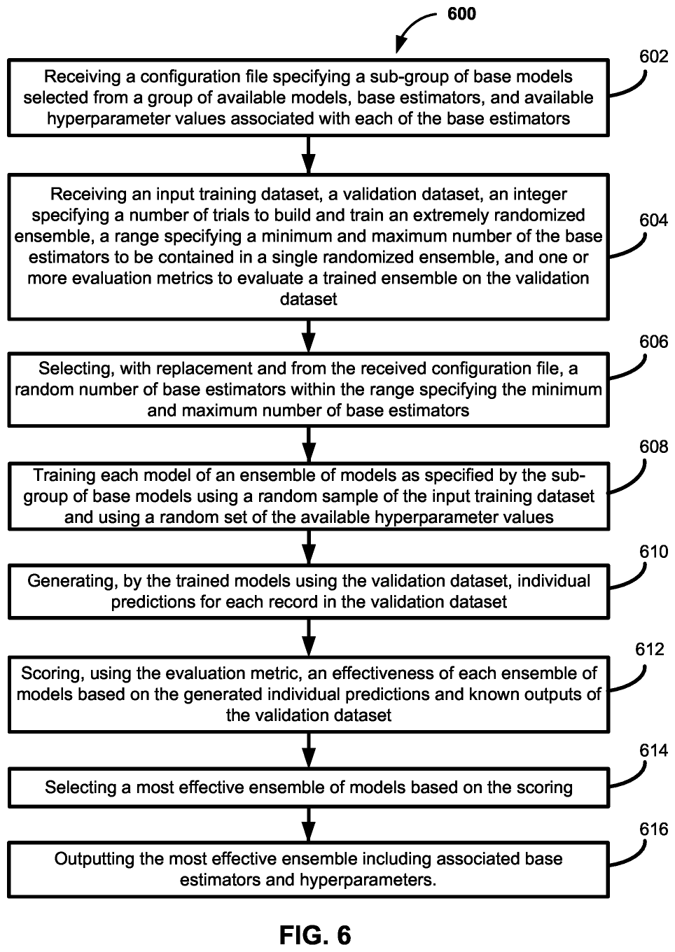

FIG. 6 is a flow diagram of a method 600 according to an exemplary implementation of the disclosed technology. The method 600 may be utilized for evaluating and selecting an ensemble of machine language models using extremely randomized bagging with replacement. In block 602, the method 600 can include receiving a configuration file specifying a sub-group of base models selected from a group of available models, base estimators, and available hyperparameter values associated with each of the base estimators. In block 604, the method 600 can include receiving an input training dataset, a validation dataset, an integer specifying a number of trials to build and train an extremely randomized ensemble, a range specifying a minimum and maximum number of the base estimators to be contained in a single randomized ensemble, and one or more evaluation metrics to evaluate a trained ensemble on the validation dataset. In block 606, the method 600 can include selecting, with replacement and from the received configuration file, a random number of base estimators within the range specifying the minimum and maximum number of base estimators. In block 608, the method 600 can include training each model of an ensemble of models as specified by the sub-group of base models using a random sample of the input training dataset and using a random set of the available hyperparameter values. In block 610, the method 600 can include generating, by the trained models using the validation dataset, individual predictions for each record in the validation dataset. In block 612, the method 600 can include scoring, using the evaluation metric, an effectiveness of each ensemble of models based on the generated individual predictions and known outputs of the validation dataset. In block 614, the method 600 can include selecting a most effective ensemble of models based on the scoring. In block 616, the method 600 can include outputting the most effective ensemble including associated base estimators and hyperparameters.

In certain exemplary implementations, the method can include selecting the most effective ensemble of models based on the scoring by averaging the individual predictions for each record and selecting the ensemble of models with the highest average of individual predictions.

In certain exemplary implementations, selecting the most effective ensemble of models may be based on determining a majority rule of correct individual predictions for each record.

In certain exemplary implementations, selecting the most effective ensemble may be performed after training a number of ensembles equal to the integer specifying the number of trials to run, build, and/or train the extremely randomized ensemble.

Certain exemplary implementations of the disclosed technology can include logging one or more of the trained models, hyperparameters used in the training, and an evaluation metric used in the scoring.

In certain exemplary implementations, a cluster of computer processors may be configured to perform the training of each model of the ensemble of models in parallel.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. Also, these components can execute from various computer readable media having various data structures stored thereon. The components may communicate by way of local and/or remote processes such as by a signal having one or more data packets, such as data from one component interacting with another component in a local system, distributed system, and/or across a network such as the Internet with other systems by way of the signal.

Certain embodiments and implementations of the disclosed technology are described above regarding block and flow diagrams of systems and methods and/or computer program products. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, can be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above concerning user devices may include mobile computing devices. Those skilled in the art recognize that there are several categories of mobile devices, generally known as portable computing devices that can run on batteries but are not usually classified as laptops. For example, mobile devices can include but are not limited to portable computers, tablet PCs, internet tablets, PDAs, ultra-mobile PCs (UMPCs), wearable devices, and smartphones. Additionally, implementations of the disclosed technology can be utilized with the internet of things (IoT) devices, smart televisions and media devices, appliances, automobiles, toys, and voice command devices, along with peripherals that interface with these devices.

It is intended that each term presented herein contemplates its broadest meaning as understood by those skilled in the art and may include all technical equivalents, which operate similarly to accomplish a similar purpose.

Ranges may be expressed herein as from “about” or “approximately” one particular value and/or to “about” or “approximately” another particular value. When such a range is expressed, another embodiment may include one particular value and/or the other particular value. Similarly, values may be expressed herein as “about” or “approximately.”

The terms “comprising” or “containing” or “including” means that at least the named element, material, or method step is present in the apparatus or method, but does not exclude the presence of other elements, materials, and/or method steps, even if the other elements, materials, and/or method steps have the same function as what is named.

The term “exemplary” as used herein is intended to mean “example” rather than “best” or “optimum.”

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” and “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Throughout the specification and the claims, the following terms take at least the meanings explicitly associated herein, unless the context dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including,” it is meant that at least the named element, or method step is present in the article or method but does not exclude the presence of other elements or method steps, even if the other such elements or method steps have the same function as what is named.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Exemplary Use Cases

The disclosed technology may be utilized to facilitate and simplify the process of building machine learning models for many diverse applications, such as predicting fraud associated with a transaction, making movie recommendations for a user based on their viewing history, predicting outcomes associated with loans, suggesting people connect to other in a social network, etc. Certain exemplary implementations of the disclosed technology may enable the elimination of one of the biggest issues associated with machine learning, which is not knowing which model to use. The disclosed technology enables finding an ensemble of different models that can be combined to provide the best performance, without having to manually select an appropriate model for the task.

In one example use case, the disclosed technology may be used to build a machine learning system to predict possible outcomes associated with automobile loans. Currently, such systems are very complicated and can require an expert user to select which machine learning model(s) will be used. The ensemble methods disclosed herein may produce very accurate predictions, as the inaccuracies tend to fade with the combinations of models used in the ensemble.

The various use case may potentially utilize many different models in an ensemble. The models for an ensemble may be randomly selected and trained on a dataset, using randomly selected data for each model with replacement, and with random hyperparameters to ensure an extremely random process. Some of the models may behave terribly, but in predictable ways.

The various use cases may utilize a configuration file to bound or define the limits of the hyperparameters, which may be used to “tune” the individual machine learning models. Common hyperparameters can be used to (a) specify the depth of the tree before a decision is made; (b) specify the number of samples on each side of a split; (c) specify how many nearest neighbors should be searched for information to make a split; etc. In certain exemplary implementations, the configuration file can list models to use, which are not restricted to just decision tree models. The configuration file may also specify the use of certain open source models.

In certain use cases, the configuration file may be set up before having a dataset. The configuration may be similar to a recipe listing exhaustive parameters for options and rules that will apply to the ensemble.

An example configuration file is shown below.

```
‘models’: {
  ‘LogisticRegression’: {
    ‘hyperparameters’: {
      ‘penalty’: {
        ‘default_value’: ‘l2’,
        ‘values’: [‘l2’, ‘none’]
      },
      ‘C’: {
        ‘default_value’: 1.,
        ‘values’: [1e−4, 1e−3, 1e−2, 1e−1, 0.5, 1., 5., 10., 15., 20., 25.]
      },
      ‘tol’: {
        ‘default_value’: 1e−4,
        ‘values’: [1e−5, 1e−4, 1e−3, 1e−2, 1e−1]
      },
      ‘max_iter’:{
        ‘default_value’: 1000,
        ‘values’: range(10, 1001)
      }
    }
  },
  ‘DecisionTreeClassifier’: {
    ‘hyperparameters’: {
      ‘criterion’: {
        ‘default_value’: ‘gini’,
        ‘values’: [‘gini’, ‘entropy’]
      },
      ‘max_depth’: {
        ‘default_value’: ‘3’,
        ‘values’: range(1, 11)
      },
      ‘min_samples_split’: {
        ‘default_value’: 10,
        ‘values’: range(2, 21)
      },
      ‘min_samples_leaf’:{
        ‘default_value’: 2,
        ‘values’: range(1, 21)
      }
    }
  },
  ‘BernoulliNB’: {
    ‘hyperparameters’: {
      ‘alpha’: {
        ‘default_value’: 0.1,
        ‘values’: [1e−3, 1e−2, 1e−1, 1., 10., 100.]
      },
      ‘fit_prior’: {
        ‘default_value’: True,
        ‘values’: [True, False]
      }
    }
  }
```

The example configuration file shown above references three models, the various hyperparameters, and associated bounds.

In general, however, a configuration file may reference hundreds of models, but the configuration file may also provide instructions to use only N of the available models for a given ensemble. The configuration file may also specify an evaluation metric, for example, to check precision-recall, and/or to determine which ensemble provides the most accurate results. It should be emphasized that the disclosed embodiments provide an extremely random process for picking which models and ensembles provide the best results, rather than requiring a user to pick which models work.

What is claimed is:

1. A method of evaluating and selecting an ensemble of machine language models using extremely randomized bootstrap aggregation with replacement, the method comprising:
receiving:
a configuration file, the configuration file specifying:
a sub-group of base models selected from a group of available models;
base estimators; and
available hyperparameter values associated with each of the base estimators;
an input training dataset;
a validation dataset;
an integer specifying a number of trials to build and train an extremely randomized ensemble;
a range specifying a minimum and maximum number of the base estimators to be contained in a single randomized ensemble; and
one or more evaluation metrics to evaluate a trained ensemble on the validation dataset;
selecting, with replacement and from the received configuration file, a random number of base estimators within the range specifying the minimum and maximum number of base estimators;
training models of an ensemble of models as specified by the sub-group of base models using a random sample of the input training dataset and using a random set of the available hyperparameter values;
generating, by the trained models using the validation dataset, individual predictions for each record in the validation dataset;
generating, using the evaluation metric, a score of each ensemble of models based on a comparison of the generated individual predictions and known outputs of the validation dataset;
selecting, based on the score, an ensemble of models; and
outputting the selected ensemble of models including associated base estimators and hyperparameters.

2. The method of claim 1, wherein selecting the most effective ensemble of models based on the scoring comprises averaging the individual predictions for each record and selecting the ensemble of models with the highest average of individual predictions.

3. The method of claim 1, wherein selecting the most effective ensemble of models is based on determining a majority rule of correct individual predictions for each record.

4. The method of claim 1, wherein the selecting the most effective ensemble is performed after training a number of ensembles equal to the integer specifying the number of trials to build and train the extremely randomized ensemble.

5. The method of claim 1, further comprising logging the trained models, hyperparameters used in the training, and an evaluation metric used in the scoring.

6. The method of claim 1, wherein a cluster of computer processors are configured to perform the training of the models of the ensemble of models in parallel.

7. A system, comprising:
a processor and memory comprising instructions that when executed by the processor cause the processor to:
receive:
a configuration file, the configuration file specifying:
a sub-group of base models selected from a group of available models;
base estimators; and
available hyperparameter values associated with each of the base estimators;
an input training dataset;
a validation dataset;
an integer specifying a number of trials to build and train an extremely randomized ensemble;
a range specifying a minimum and maximum number of the base estimators to be contained in a single randomized ensemble;
one or more evaluation metrics to evaluate a trained ensemble on the validation dataset;
select, with replacement and from the received configuration file, a random number of base estimators within the range specifying the minimum and maximum number of base estimators;
train models of an ensemble of models as specified by the sub-group of base models using a random sample of the input training dataset and using a random set of the available hyperparameter values;
generate, by the trained models using the validation dataset, individual predictions for each record in the validation dataset;
generate, using the evaluation metric, a score of each ensemble of models based on a comparison of the generated individual predictions and known outputs of the validation dataset;
select, based on the score, an ensemble of models; and
output the selected ensemble of models including associated base estimators and hyperparameters.

8. The system of claim 7, wherein selecting the most effective ensemble of models based on the scoring comprises averaging the individual predictions for each record and selecting the ensemble of models with the highest average of individual predictions.

9. The system of claim 7, wherein selecting the most effective ensemble of models is based on determining a majority rule of correct individual predictions for each record.

10. The system of claim 7, wherein the selecting the most effective ensemble is performed after training a number of ensembles equal to the integer specifying the number of trials to build and train the extremely randomized ensemble.

11. The system of claim 7, further comprising logging the trained models, hyperparameters used in the training, and an evaluation metric used in the scoring.

12. The system of claim 7, wherein a cluster of computer processors are configured to perform the training of the models of the ensemble of models in parallel.

13. The system of claim 7, wherein the models are not limited to decision trees.

14. A non-transitory computer-readable medium comprising a set of instructions that, in response to being executed by a processor circuit, cause the processor circuit to perform a method of:
receiving:
a configuration file, the configuration file specifying:
a sub-group of base models selected from a group of available models;
base estimators; and
available hyperparameter values associated with each of the base estimators;
an input training dataset;
a validation dataset;
an integer specifying a number of trials to build and train an extremely randomized ensemble;
a range specifying a minimum and maximum number of the base estimators to be contained in a single randomized ensemble; and
one or more evaluation metrics to evaluate a trained ensemble on the validation dataset;
selecting, with replacement and from the received configuration file, a random number of base estimators within the range specifying the minimum and maximum number of base estimators;
training models of an ensemble of models as specified by the sub-group of base models using a random sample of the input training dataset and using a random set of the available hyperparameter values;
generating, by the trained models using the validation dataset, individual predictions for each record in the validation dataset;
generating, using the evaluation metric, a score of each ensemble of models based on a comparison of the generated individual predictions and known outputs of the validation dataset;
selecting, based on the score, an ensemble of models; and
outputting the selected ensemble of models including associated base estimators and hyperparameters.

15. The non-transitory computer-readable medium of claim 14, wherein selecting the most effective ensemble of models based on the scoring comprises averaging the individual predictions for each record and selecting the ensemble of models with the highest average of individual predictions.

16. The non-transitory computer-readable medium of claim 14, wherein selecting the most effective ensemble of models is based on determining a majority rule of correct individual predictions for each record.

17. The non-transitory computer-readable medium of claim 14, wherein the selecting the most effective ensemble is performed after training a number of ensembles equal to the integer specifying the number of trials to build and train the extremely randomized ensemble.

18. The non-transitory computer-readable medium of claim 14, further comprising logging the trained models, hyperparameters used in the training, and an evaluation metric used in the scoring.

19. The non-transitory computer-readable medium of claim 14, wherein a cluster of computer processors are configured to perform the training the models of the ensemble of models in parallel.

20. The non-transitory computer-readable medium of claim 14, wherein the models are not limited to decision trees.
